(19) United States
(12) Patent Application Publication
(10) Pub. No.: US 2001/0034986 A1
(43) Pub. Date: Nov. 1, 2001

(54) Combined window insert and finishing apparatus

(76) Inventors: Godfrey Thomas, Lethbridge (CA); Henry Dekort, Chestermere (CA); Russell Thomas, Calgary (CA)

Correspondence Address: SEAN W. GOODWIN, 237- 8TH AVE. S.E., SUITE 660, THE BURNS BUILDING, CALGARY, AB, T2G 5C3, CA

(21) Appl. No.: 09/843,733

(22) Filed: Apr. 30, 2001

Related U.S. Application Data
(60) Provisional application No. 60/201,313, filed on May 2, 2000.

(51) Int. Cl. E06B 3/30; E06B 3/00; E06B 7/14; E06B 1/04; E04C 2/38

(52) U.S. Cl. 52/211; 52/745.15; 52/204.54; 52/208; 52/209; 52/215; 52/656.2; 52/656.5; 52/656.6; 52/656.9; 49/504

(57) ABSTRACT

A unitary window insert and method of insertion into a wall structure for forming a finished surround for a window unit. The unitary insert comprises a frame portion sized and shaped to accept a window unit, from which planer finishing wall portions extend to a casing flange which surrounds the interior edge of the insert. Preferably the finishing walls are flared inward creating a pyramidal frustum having an opening larger at the interior surface of the wall than at the exterior surface. The insert extends through the wall structure from an exterior surface and to an interior surface. In the case of poured concrete walls, the insert is provided with a spacer or panel to support the frame portion during construction.

### CROSS REFERENCES TO RELATED APPLICATIONS

This application claims the benefits under U.S.C. §119(e) of US provisional application 60/201,313, filed May 02, 2000, which is incorporated herein by reference in its entirety.

### FIELD OF THE INVENTION

The present invention relates to one-piece window inserts which form a finished window surround, which does not require any further finishing.

### BACKGROUND OF THE INVENTION

In conventional construction, a wooden framed box or window insert is secured between the inner and outer forms of a concrete foundation wall. After the concrete has been poured, set and cured, the outer walls of the cribbing are removed and the insert remains in place in the wall structure. In framed or cinder block construction, a window opening is framed with a wooden header and peripheral studs.

In both cases, a glass-paned window unit is secured to the insert or framing and the portion that remains visible towards the inside of the wall structure must be finished to create a desirable visual appearance, continuous with the interior wall finishing. Typically, a glass-paned window unit is installed which is shimmed in place, drywall is finished about the window unit, and casing is added.

In the cases of concrete construction, the window inserts are formed of a rectangular construction which present peripheral flat surfaces which lie perpendicular to the plane of the wall structure and are retained only by a frictional engagement of the insert's peripheral surfaces and the concrete.

### SUMMARY OF THE INVENTION

Apparatus and method for finishing a window opening in a framed or poured concrete wall structure. A unitary window insert is provided, having a frame portion sized and shaped to accept the desired window unit, and planar finishing walls, extending from the interior periphery of the frame portion, to finish the interior of the window opening. The insert extends from an exterior surface of the wall structure through the wall to an interior surface of the wall structure. Further, a casing flange extends about the periphery of the interior edge of the insert for finishing the interior edge.

In a preferred embodiment of the invention, the planar finishing walls are flared from the frame portion to the interior edge of the insert forming a pyramidal frustum, having an interior wall edge periphery greater than the frame portion of the insert to allow more light to enter the room and give the appearance of larger windows. Additionally, the flared sill permits easier egress from the window in the case of fire or other danger. One or more of the finishing walls can be flared to provide a suitable insert for different window locations and dimensional restrictions. For example, a basement window having the head situated adjacent the ceiling may only permit flaring of the side and bottom walls only to create an appealing appearance.

In a method applied to framed construction, the insert is simply installed by positioning the unitary insert in the window opening where it spans from interior surface to exterior surface and then securing it to the framing. Preferably, the casing flange can extend over the surface of the interior wall to finish the interior edge and can further be used to secure the insert, either mechanically or using an adhesive. The exterior wall panel of the insert is removed by cutting with a saw or router. The window unit can be installed from the exterior and is secured into place by fastening the nailing fin to the insert through the nailing members.

In a method applied to poured concrete construction, the insert is positioned between the cribbing walls and secured to the concrete framing, often a ladder constructed of 2×4's used to support and space the cribbing walls. Concrete is poured around the insert and is allowed to dry and cure. In one embodiment of the invention the casing flange has segments which project or extend into the concrete wall structure for securing the insert in place once the concrete has set. Once cured, the exterior wall panel of the insert is removed as for the framed construction and the window unit is installed.

In another embodiment of the invention the window insert is formed without the exterior wall panel and a supporting spacer is removably positioned inside the insert to support and space the walls during concrete pouring. Preferably, the supporting spacer is a cardboard honeycomb grid, which additionally allows concrete ties to be placed therethrough for supporting cribbing walls for concrete wall construction.

In another embodiment of the invention, the window insert is formed of linear shaped panels, the panels joined by corresponding tabs and slots at their ends. When four linear panels are arranged to form a unitary, parallelepiped, the tab of one panel is fit into the slot at an adjacent, opposing end of an adjacent panel and is retained in the slot using a pin.

Once installed, the window insert extends through the wall structure from exterior to interior and finishes the window opening. The insert is formed of molded plastic, such as ABS or PVC, which requires no additional finishing, however, if desired the surface can be painted to match the room's décor.

### BRIEF DESCRIPTION OF THE DRAWINGS

FIG. 1 is a cross-sectional view of an oven (partially shown) and a plastic sheet poised over a vacuum forming mold;

FIG. 2 is a cross-sectional view of the vacuum forming mold of FIG. 1 in which the plastic has been vacuum formed into one embodiment of the window insert of the present invention;

FIG. 3 is a cross-sectional view of the window insert of FIG. 2, complete with flashing;

FIG. 4a is a cross-sectional view of the window insert of FIG. 3 illustrating one option for removal of peripheral flashing and window inset panel is removed;

FIGS. 4b and 4c are cross-sectional views of the window insert illustrating alternate flashing configurations according to FIG. 4a;

FIG. 5a is a perspective view of the window insert of FIG. 3, viewed from the outside, which is fitted with 2×2 support members, and which is in a form prior to removal of the flashing and outside inset panel;

FIG. 5b is an exploded partial view of the corresponding corner Vb of FIG. 5a showing an alternate embodiment of the invention;

FIG. 6a is a perspective view of the window insert of FIG. 3, viewed from the inside, which is fitted with a honeycomb supporting spacer;

FIG. 6b is an exploded plan view of a honeycomb supporting structure illustrating the interlocking slotted vertical and horizontal members;

FIG. 7a is a cross sectional view of the window insert of FIG. 4 permanently installed a concrete wall structure and with the outside inset panel removed for installation of the window unit;

FIG. 7b is a front view of the window insert of FIG. 6a, installed in a wall structure, with the window unit installed, sectioned along line VIIb-VIIb of FIG. 7a;

FIG. 8a is a cross sectional view of the window insert of FIG. 4 with the window unit installed;

FIG. 8b is an inside wall, front sectional view of the installed window insert, sectioned along line VIIIb-VIIIb of FIG. 8a; and

FIG. 9 is a partial, perspective cutaway view of half of a window insert positioned in concrete forms in preparation for pouring concrete.

### DETAILED DESCRIPTION OF THE PREFERRED EMBODIMENT

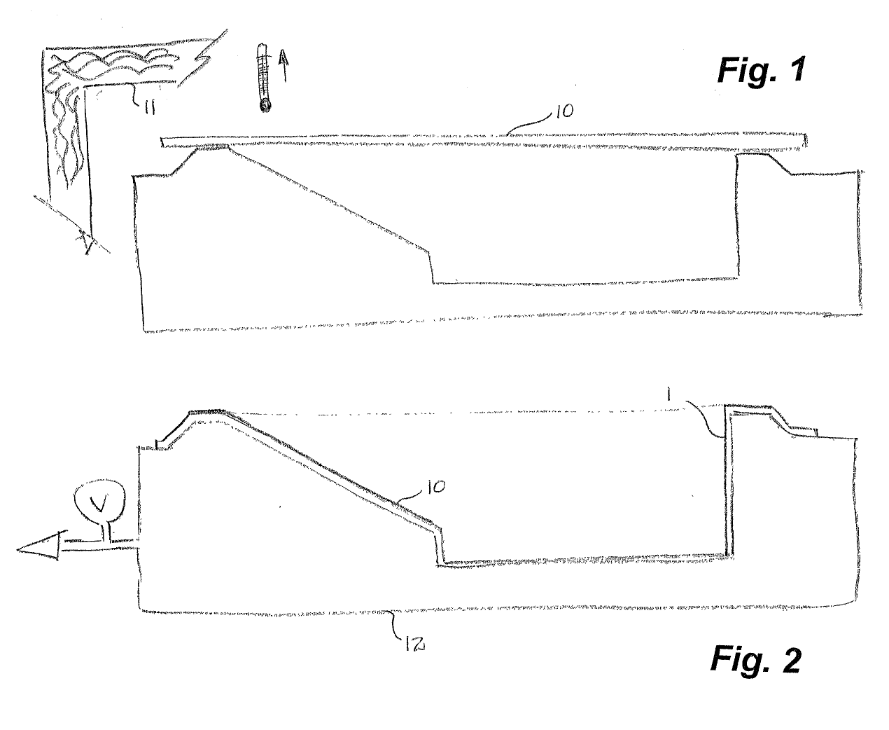

As shown in FIGS. 1-4, a window insert 1 is formed as a unitary structure or window insert having a finished surround appearance. Preferably the insert is stamped of lightweight metal or is formed using robust plastic, such as ABS or PVC. It is believed that the plastic insert provides a superior strength to weight ratio and better retains its finished appearance if scratched.

The insert 1 is typically installed into an opening in a concrete wall structure or acts as the concrete form or buck for the opening, but it also works equally well for an opening in any wall structure into which a finished window unit would normally be installed.

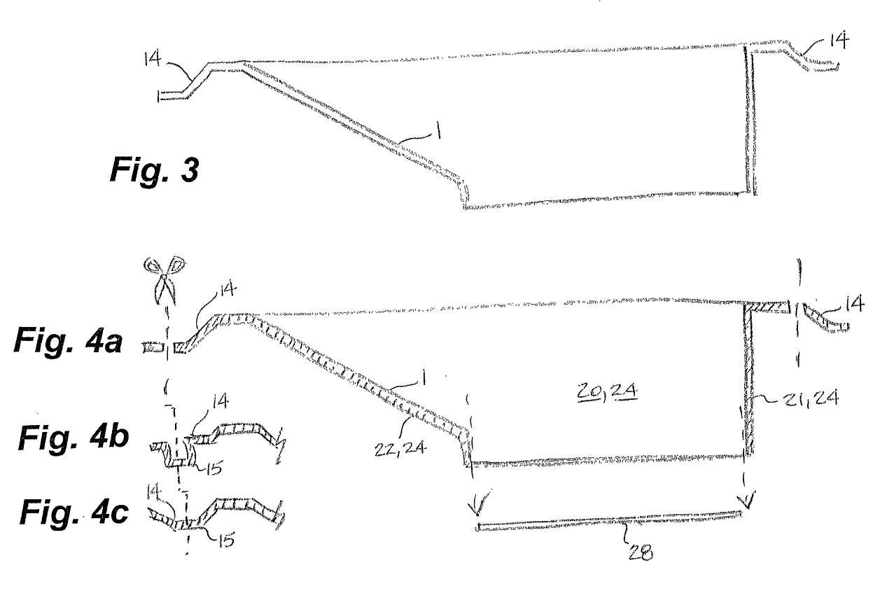

Using a vacuum-forming method of manufacturing in FIG. 1, a flat plastic panel 10 is heated in an oven 11. In FIG. 2, the panel 10 is vacuum-formed into the mold or pattern 12. In FIG. 3, the one-piece and unitary formed insert 1 is pulled from the pattern 12 and has some flashing 14; some of which is removed at various stages. As shown in FIGS. 4a-4c, the flashing 14, can have various configurations. The majority of the unheated flashing 14 is removed to minimize warping of the edge of the insert, however, in some cases a small portion of a moat 15 surrounding the flashing 14 can be optionally retained to assist in providing structural rigidity.

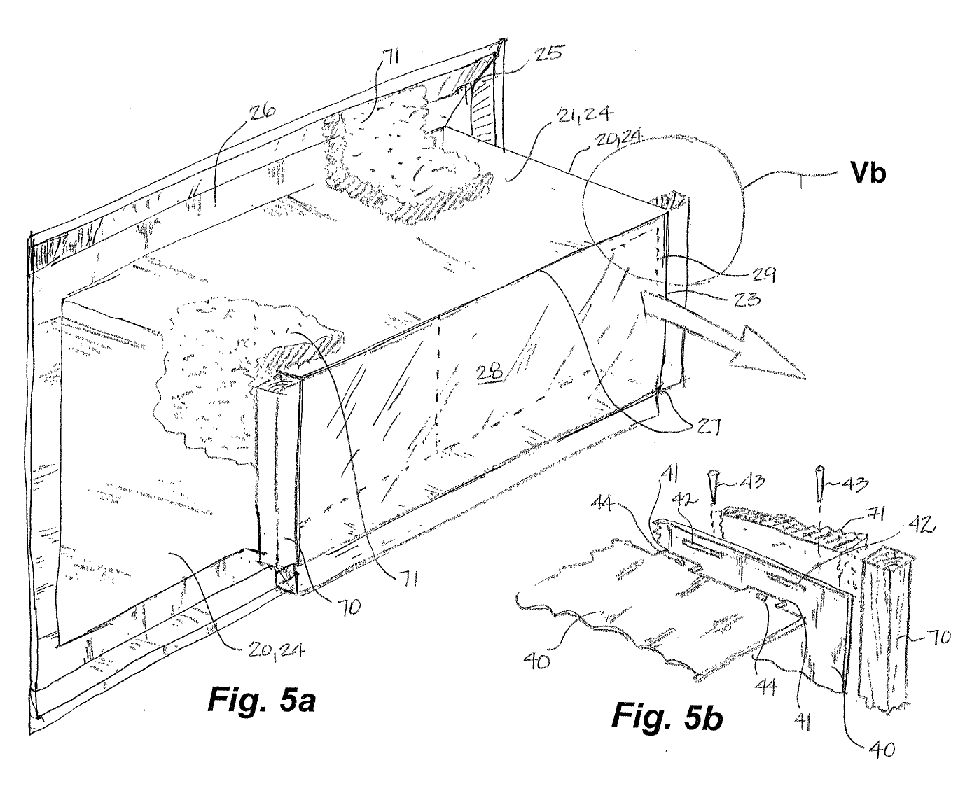

Having reference to FIG. 4a and 5a, the finished three-dimensional insert 1 is primarily a polygonal box surround having two vertical jambs 20, a head 21 and a sill 22 which form a frame portion 23 for a glass-paned window unit. Planar finishing walls 24 extend inwardly from the frame portion 23 to finish the window opening. The planer finishing walls 24 extend to an interior edge 25. A flange 26 extends about the periphery of the interior edge 25, forming a casing. The frame portion 23 has an exterior periphery 27 which corresponds in size and shape to the window unit to be installed.

In one embodiment of the invention, as shown in FIG. 4a, the insert 1 is initially molded with an exterior wall panel 28 at the exterior periphery 27 of the frame portion 23; the shape corresponding to a window unit, typically rectangular. This panel 28 is a residual structure from the vacuum forming manufacturing process and further acts to space the jambs 20, head 21 and sill 22, and lends dimensional support to the insert's edges 27 and planer finishing walls 24 during installation. A substantial portion of exterior wall panel 28 is eventually cut out (FIGS. 4a, 5a) so that when a window unit is installed the panel 28 does not impede viewing therethrough. A small lip portion 29 of the exterior wall panel 28 can be retained about the exterior periphery 27 to add structural rigidity. Note that the illustrated and preferred frame portion 23 is sized to match conventional rectangular window units. Ideally, the exterior edge 27 of the frame portion 23 is arranged in the form of a rectangular parallelepiped so as to properly support the window unit. Due to the preferred vacuum-forming method, the walls may have a small amount of draft to aid in removal from the pattern.

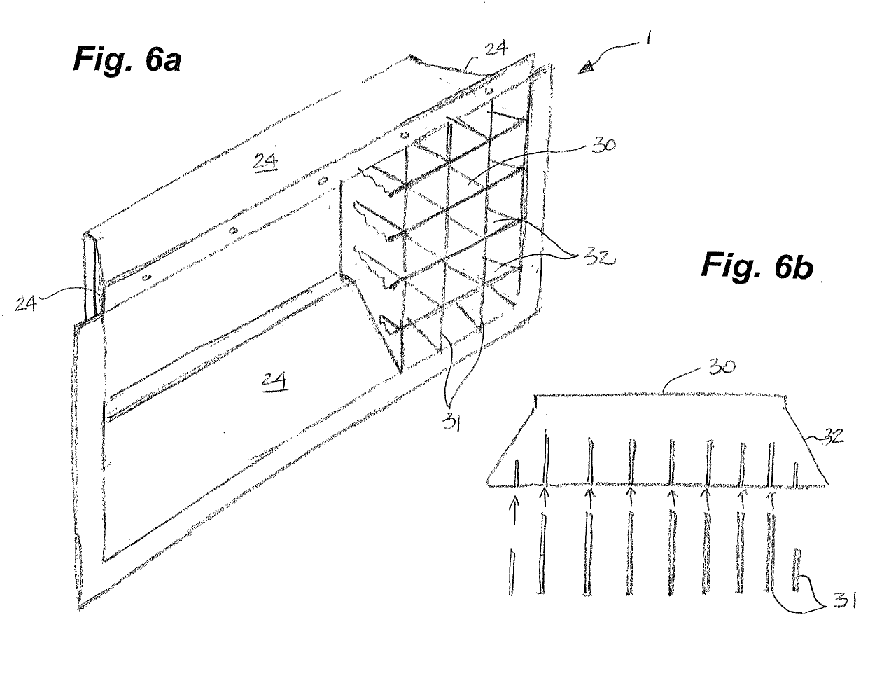

Having reference to FIGS. 6a, 6b, in another embodiment of the invention, the window insert 1 is formed as described above and the exterior wall panel 28 is removed prior to use. A removable supporting spacer 30 is placed inside the window insert 1 to support and space the planar walls 24 of the insert during concrete pouring. Preferably, the supporting spacer 30 is an economical cardboard honeycomb structure comprising a plurality of vertical slotted members 31 and horizontal slotted members 32 which form openings therethrough. Concrete form ties (not shown), typically used to support cribbing walls on either side of concrete wall to be poured, can then be passed through the openings in the spacer 30 Once the concrete has been poured and cured, the concrete ties can be cut and the cardboard spacer 30 removed from the window insert 1.

The vacuum forming or other forming methods are not restricted to the rectangular, and could also include polygonal or round inserts.

Having reference to FIG. 5b, in another embodiment of the invention, the insert 1 is formed from a plurality of linear shaped panels 40. The panels 40 can be formed through extrusion methods. Each panel has at least one tab 41 or slot 42. When arranged to form a parallelepiped, the tab 41 of one adjacent panel 40 is fit into the slot 42 of the next adjacent panel 40. The tabs 41 are retained in the slots 42 using means such as a pin 43 placed through a complementary hole 44 in the tab 41.

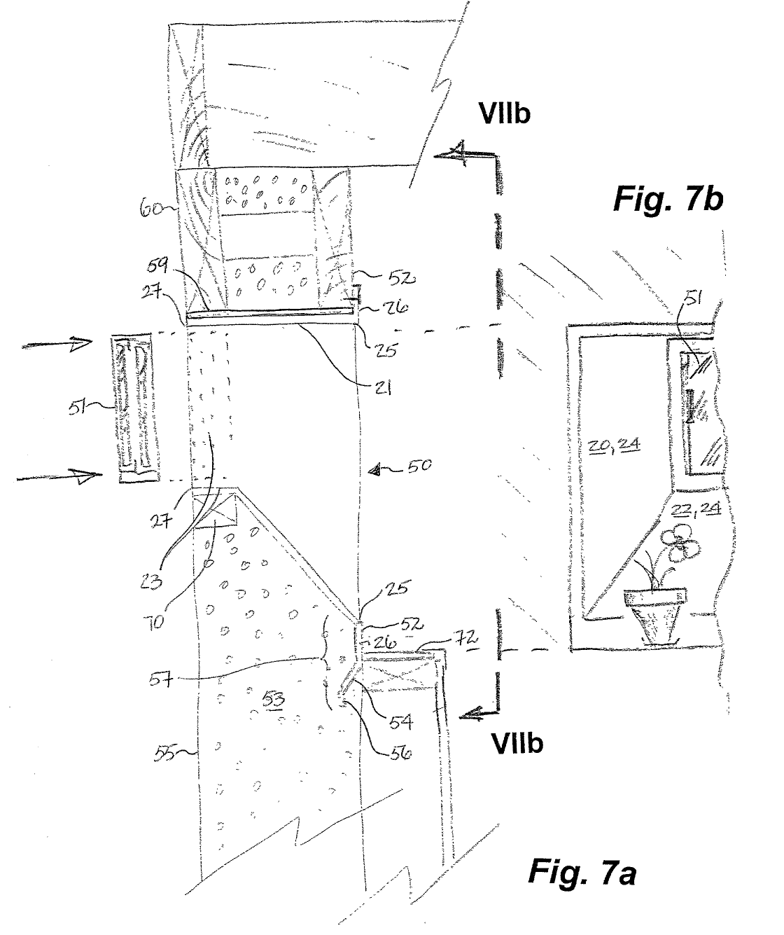

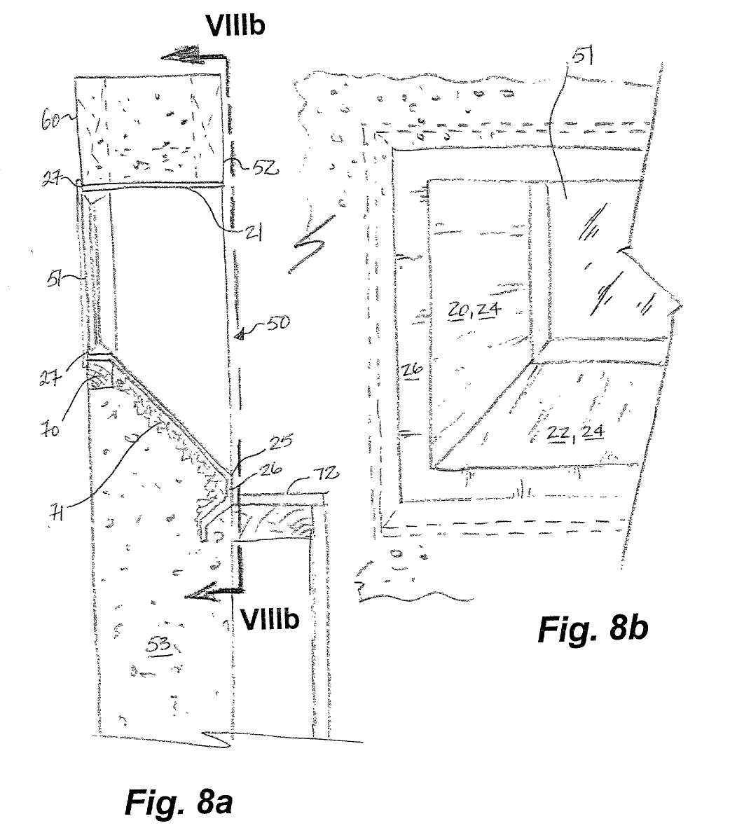

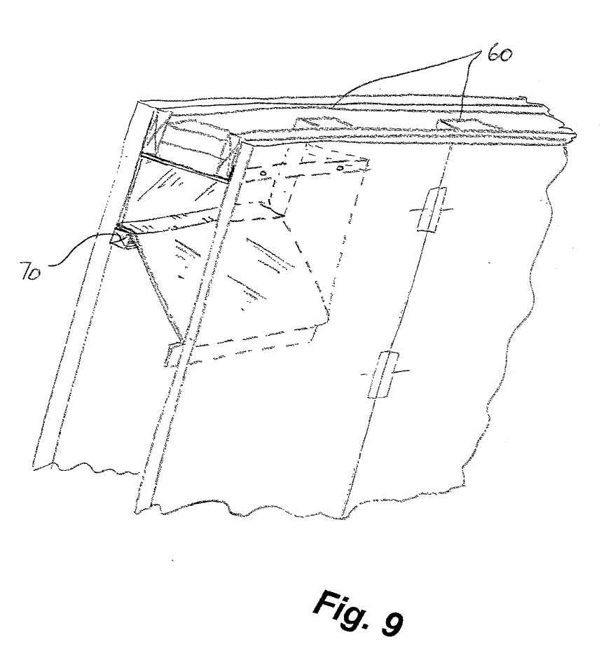

Turning to FIGS. 7a-8b, for improved conveyance of light through the insert 1, the planer finishing walls 24 of the insert are formed with a beveled or flared opening 50 at the interior edge 25, forming a pyramidal frustum. Accordingly, the interior edge 25 of the insert 1 is larger than the exterior edge 27. A window unit 51 is fitted into the frame portion 23.

The insert 1 is usually colored, preferably white, to obtain maximal light transmission and to comply with current accepted decorating schemes. The insert 1 has a finished surface, which does not require further finishing and, thus, avoids the need for smoothing compounds, sanding or painting. Of course, if the original color is later deemed inappropriate, paint can be applied.

More particularly, each planar side wall 24 extends inwardly from the frame portion 23. Preferably, the jamb's 20 planar walls 24 angle laterally while extending inwardly from the frame portion 23 to the interior edge 25 and surface 52 of wall 53. Similarly, the sill's 22 planar wall 24 angles downwardly from the frame portion 23 to the wall's interior surface 52, creating a beveled interior opening 50 which is significantly larger than the frame portion's exterior edge 27.

One or more of the planer finishing walls 24, including the jamb 20, head 21 and sill's 22 walls 24 can be flared as described above, depending upon the desired light entry effect and dimensional restrictions imposed by the location or placement of the window.

As shown in FIGS. 3, 4 and 5-7b the casing flange 26 is formed about the periphery of the interior opening. The casing flange 26 extends from the insert's interior edge 25 and parallel to the wall's interior surface 52. The flange 26, while acting to decoratively finish the edge of the window opening 50, can also act as a means for fastening the insert 1 to the wall 53, whether framed or poured in place in concrete construction.

Optionally, when used as a form for the opening 50 in a poured concrete wall 53, the casing flange 26 can be formed and a portion of the flashing 14 retained at least one segment 54 which angles back into the intended volume of the concrete wall 53. The retained flashing 14 comprises at least two segments; the first segment as described for the casing 26 and a second segment 54 directed at an obtuse angle from the casing flange 26 and towards the exterior surface 55 of wall 53. Accordingly, when poured, the second segment 54 becomes embedded into the concrete wall 53. A third segment 56 is reoriented at an obtuse angle to extend substantially parallel again to the first casing flange segment 26, creating an angled catch 57 which resists removal from the concrete, once set. Further, forming a catch 57 with one or more angles strengthens the casing flange 26 and ensures it remains planer during installation. This is useful for concrete installations where the window insert 1 provides the form for the concrete and must restrain some hydraulic fluid concrete pressure.

In one form of concrete wall construction, the insert 1 is secured to a ladder 60 constructed of two 2×4's set on edge and separated at regular intervals by 2×4 spacing members, which span between the upper edges of the inner and outer concrete cribbing walls. Attached to the ladder 60 the window insert 1 remains in place during the pouring process.

Optionally, if the flashing 14 is formed to have more than one angled segment 26, 54, 56, the catch 57 extends upwards and inwards from the sides and lower edge of the interior opening and becomes embedded in the concrete, thus securing and sealing the insert 1 in the wall 53.

In one embodiment of the invention, the exterior wall panel 28 of the insert 1 remains intact (FIG. 3) during the framing or pouring process to provide rigidity and strength to the insert. After the structure around the insert 1 is rigid (concrete walls have been set and cured), the exterior wall panel 28, which aligns rigidity and strength to the insert. After the structure around the insert 1 is rigid (concrete walls have been set and cured), the exterior wall panel 28, which aligns with the exterior surface 55 of the concrete wall 53, is removed (FIGS. 4a and 5a), using a cutter, such as a saw or router. Substantially the entire exterior wall panel 28 is removed, leaving only the edges of the four planar walls 24 exposed or a small residual inward lip 29, as shown in FIG. 5a. The window unit 51 is installed in its place, from outside the insert 1, and is secured to the insert 1 by a nailing fin (not shown) formed about the window unit 51.

Preferably, as shown in FIGS. 5a, 5b and 9, 2″×2″ nailer members 70 are fastened to three sides of the periphery of the insert frame portion 23 outside each jamb 20 and the sill 22, to provide sufficient material to which the window unit 51 can be secured after concrete is poured. Optionally, as shown in FIG. 7a, a piece of thin plywood 59 may be fastened at the head 21 for aiding in support and in securing the insert 1 to the ladder 60.

Further, as shown in FIGS. 5a, 5b, 8a, insulation 71 is affixed to the outside 24, 526 of the insert 1 to prevent cold from penetrating the insert 1. Preferably, foam insulation 71 is spray coated to provide an even layer of semi-rigid foam material that aids in preventing condensation and also acts to provide additional rigidity to the insert 1.

Having reference to FIGS. 7a-8a, a 2×4″ or 2×6″ frost wall can be built against the inside surface 52 of the concrete wall 53 creating a ledge 72 where the wall 53 meets the casing flange 26.

Formed and installed in this manner, the one-piece insert 1 eliminates the need to further finish the window opening 50. Additionally, by forming an optional flare into the insert 1, enhanced light capability and also a distinctive architectural aspect is also added to the window opening 50.

The embodiments of the invention for which an exclusive property or privilege is claimed are defined as follows:

1. A unitary window insert for insertion into an opening in a wall and which forms a finished surround for a window unit, the wall having an exterior wall and an interior wall, the insert comprising:
(a) a frame portion having an exterior periphery at the exterior wall, the frame portion corresponding in size and shape for receiving the window unit;
(b) planer finishing walls extending inwardly from the frame portion to an interior edge so that when the insert is inserted into the wall, the planer finishing walls extend to the interior wall; and
(c) a flange extending from the interior edge and at least a portion of which lies substantially parallel to an interior surface of the wall so as to form a casing.

2. The unitary window insert of claim 1 wherein the unitary insert is formed from plastic.

3. The unitary window insert of claim 1 wherein the frame portion comprises a head, a sill and two jambs.

4. The unitary window insert of claim 3 wherein the insert further comprises an exterior wall panel for spacing the frame portion, the panel being adapted for removal.

5. The unitary window insert of claim 3 wherein the insert further comprises a removable spacer for placing within the insert for supporting the frame portion and planar finishing walls.

6. The unitary window insert of claim 5 wherein the supporting spacer is a honeycomb structure.

7. The unitary window insert of claim 1 wherein the insert is inserted into an opening formed in a concrete wall structure.

8. The unitary window insert of claim 7 wherein the insert further comprises an exterior wall panel for spacing the frame portion around which the concrete wall can be poured, the panel being adapted for removal after the poured concrete sets.

9. The unitary window insert of claim 1 wherein the insert is inserted into an opening in a framed wall structure.

10. The unitary window insert of claim 1 wherein one or more of the insert's planer finishing walls is flared from the frame portion to the interior edge.

11. The unitary window insert of claim 10 wherein the flared planar finishing walls of the insert form a pyramidal frustum having an interior edge larger than the frame portion's exterior periphery.

12. The unitary window insert of claim 8 inserted in a poured concrete wall wherein the casing flange comprises at least first and second segments,
the first segment extending from the interior edge and lying parallel to the interior wall, and
the second segment extending at an obtuse angle from the first segment and towards an exterior surface of the exterior wall so as to be positioned for embedding in the poured concrete.

13. The unitary window insert of claim 9 wherein the casing flange further comprises at least a third segment which extends at an obtuse angle from the second segment and forwards toward the interior wall again so as to hinder extraction from its embedded position in the concrete wall.

14. A method for forming a finished window opening in a poured concrete wall having interior and exterior wall cribbing, the finished window opening ready for receiving a window unit, the method comprising the steps of:
providing a unitary window insert comprising a frame portion whose periphery is sized and shaped to accept the window unit and which is spaced by an exterior panel, planer walls having a finished inside surface extending from the frame portion, and an interior edge having a flange to act as a casing;
installing the insert between the inside and outside wall cribbing;
pouring concrete between the wall cribbing; and
removing the exterior panel once the concrete has set.

15. A method for forming a finished window opening in a poured concrete wall having interior and exterior wall cribbing, the finished window opening ready for receiving a window unit, the method comprising the steps of:
providing a unitary window insert comprising a frame portion whose periphery is sized and shaped to accept the window unit and which is spaced by planer walls having a finished inside surface extending from the frame portion, an interior edge having a flange to act as a casing and a removable supporting spacer;
installing the insert between the inside and outside wall cribbing;
pouring concrete between the wall cribbing; and
removing the supporting spacer once the concrete has set.

16. A method of forming a finished window opening in a framed construction wall having an interior wall and exterior wall, the finished window opening ready for receiving a window unit, the method comprising the steps of:
providing a unitary window insert having a frame portion whose periphery is sized and shaped to accept the window unit, planer walls having a finished inside surface extending from the frame portion and an interior edge having a flange to act as a casing
installing the insert between the inside and outside wall; and
fastening the insert to the framed wall.

17. The method of forming a finished window opening as described in claim 16, wherein the frame portion is spaced by an exterior panel, the method further comprising the step of removing the exterior panel from the insert.

18. The method of forming a finished window opening as described in claim 16, wherein the frame portion is spaced by a supporting spacer, the method further comprising the step of removing the supporting spacer from the insert.

19. A method of forming a unitary window insert for forming a finished surround for a window unit when inserting into and opening in a wall structure having an exterior wall and an interior wall, the method comprising the step of:
vacuum forming an insert having a frame portion forming a periphery having an exterior periphery at the exterior wall, the frame portion corresponding in size and shape for receiving the window unit, planar walls extending inwardly from the frame portion to an interior edge so that when the insert is inserted into the wall structure, the planar walls extend to the interior wall and a flange extending from the interior edge and at least a portion which lies substantially parallel to an interior surface of the wall structure so as to form a casing.

20. The method of claim 19 further comprising the step of removing a portion of the flange.

21. The method of claim 19 wherein one or more of the insert's planar walls is flared from the frame portion to the interior edge.

22. A method of forming a unitary window insert for forming a finished surround for a window unit when inserting into an opening in a wall structure having an exterior wall and an interior wall, the method comprising the steps of:
providing four linear shaped panels, each panel having a first and second end, a tab or a slot formed at either the first or second end;
arranging and abutting the ends of the linear panels so as to form a parallelepiped; and
aligning corresponding tabs and slots for connecting the adjacent abutting ends of the panels.

23. The method of claim 22 wherein one or more of the insert's planar walls is flared from the frame portion to the interior edge.

24. A unitary window insert produced according to the method of claim 19.

25. A unitary window insert produced according to the method of claim 22.
